(19) United States
(12) Patent Application Publication
(10) Pub. No.: US 2014/0118294 A1
(43) Pub. Date: May 1, 2014

(54) DISPLAY PROCESSOR AND DISPLAY PROCESSING METHOD

(71) Applicant: Kabushiki Kaisha Toshiba, Tokyo (JP)

(72) Inventor: Masahiro YAMADA, Tokyo (JP)

(21) Appl. No.: 13/917,378

(22) Filed: Jun. 13, 2013

(30) Foreign Application Priority Data
Oct. 25, 2012 (JP) 2012-236085

(51) Int. Cl. G06F 3/044

(52) U.S. Cl. CPC G06F 3/044
USPC 345/174

(57) ABSTRACT

According to one embodiment, a display processor includes: a receiver configured to receive from a mobile terminal an acceleration detection signal indicating acceleration generated in the mobile terminal; a display including a display area; a detector configured to detect a touch on the display area of the display; and a controller configured to perform processing corresponding to the display area when a difference between a time when the detector detects the touch and a time when the receiver receives the acceleration detection signal is within a predetermined threshold.

### CROSS-REFERENCE TO RELATED APPLICATIONS

This application is based upon and claims the benefit of priority from Japanese Patent Application No. 2012-236085, filed Oct. 25, 2012, the entire contents of which are incorporated herein by reference.

### FIELD

An embodiment described herein relates generally to a display processor and a display processing method.

### BACKGROUND

Operation displays have been known that comprise touch panels as user interfaces. In an example of such operation displays, a predetermined program associated with an icon displayed on the user interface is activated when a user touches the icon with the user's finger or a designated terminal, for example.

When the icon displayed by the operation display is touched with a terminal, techniques have been known that perform, between the terminal and the operation display, processing corresponding to the icon to which the terminal is touched and the terminal.

Under a situation where a plurality of terminals are available with which the operation display can communicate, conventional techniques may fail to identify the terminal touched to the operation display and to perform processing appropriate to the terminal.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary hardware structural view of an operation display according to an embodiment;

FIG. 2 is an exemplary schematic diagram illustrating a modification example in which images are displayed on a wall surface using a projector as a display;

FIG. 3 is an exemplary schematic diagram illustrating a data structure of an icon data table stored in an icon storage in the embodiment;

FIG. 4 is an exemplary hardware structural view of a mobile terminal in the embodiment;

FIGS. 5A, 5B, and 5C are exemplary schematic diagrams illustrating a user interface screen when the operation display in the embodiment executes a terminal cooperation program;

FIG. 6 is an exemplary schematic diagram illustrating a timing chart when cooperative processing is performed between the operation display and the mobile terminal in the embodiment;

FIG. 7 is an exemplary diagram illustrating a case where a time when an acceleration detection signal is received from a first mobile terminal and a time when the acceleration detection signal is received from a second mobile terminal are very close to a time when a detection signal is received;

FIGS. 8A to 8E are exemplary schematic diagrams illustrating a transition of a screen displayed when the mobile terminal in the embodiment is touched to the display;

FIG. 9 is an exemplary flowchart illustrating a procedure of processing from identification of a program to the start of communication in the operation display in the embodiment;

FIG. 10 is an exemplary flowchart illustrating a procedure of processing up to the start of communication in the operation display in the embodiment;

FIG. 11 is an exemplary flowchart illustrating a procedure of processing when an icon to which the mobile terminal is touched is related to a moving image in the operation display in the embodiment;

FIG. 12 is an exemplary flowchart illustrating a procedure of processing when an icon to which the mobile terminal is touched is related to music in the operation display in the embodiment;

FIG. 13 is an exemplary flowchart illustrating a procedure of processing when an icon to which the mobile terminal is touched is related to a photograph in the operation display in the embodiment;

FIG. 14 is an exemplary flowchart illustrating a procedure of processing when an icon to which the mobile terminal is touched is related to uploading in the operation display in the embodiment;

FIG. 15 is an exemplary schematic diagram illustrating a screen for payment displayed when a user wants to buy a product;

FIG. 16 is an exemplary schematic diagram illustrating the user interface screen when the operation display according to a first modification of the embodiment executes the terminal cooperation program;

FIG. 17 is an exemplary schematic diagram illustrating the user interface screen when an access limitation is canceled so as to access data stored in the storage of the operation display according to a second modification of the embodiment;

FIG. 18 is an exemplary flowchart illustrating a procedure of processing up to the start of communication in the operation display in the second modification of the embodiment; and

FIG. 19 is an exemplary flowchart illustrating a procedure of processing up to the start of communication in the operation display according to a third modification of the embodiment.

### DETAILED DESCRIPTION

In general, according to one embodiment, a display processor comprises: a receiver configured to receive from a mobile terminal an acceleration detection signal indicating acceleration generated in the mobile terminal; a display comprising a display area; a detector configured to detect a touch on the display area of the display; and a controller configured to perform processing corresponding to the display area when a difference between a time when the detector detects the touch and a time when the receiver receives the acceleration detection signal is within a predetermined threshold.

An embodiment of an operation display to which a display processor and a display processing method are applied is described below with reference to the accompanying drawings. The embodiment does not limit the invention.

### Embodiment

An operation display according to the embodiment displays a user interface screen on a touch panel display. The operation display performs predetermined processing by detecting a touch on the user interface screen. A smartphone can be used as a mobile terminal, for example. Other dedicated devices may be used as the mobile terminal. For example, a device having a pen shape may be used.

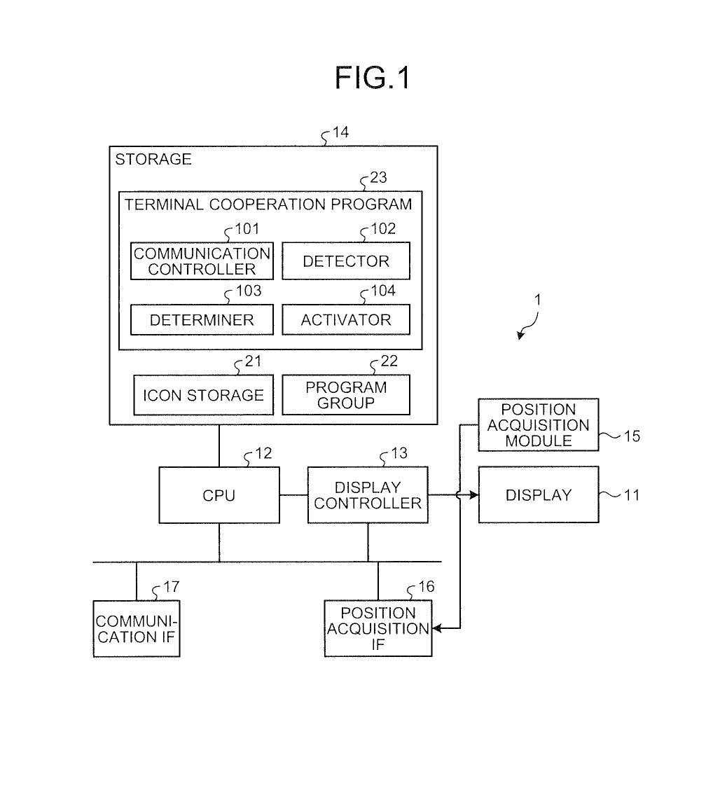

FIG. 1 is a hardware structural view of this operation display 1 in the embodiment. As illustrated in FIG. 1, the operation display 1 comprises a display 11, a central processing unit (CPU) 12, a display controller 13, a storage 14, a position acquisition module 15, a position acquisition interface (IF) 16, and a communication IF 17.

The display 11, which comprises a liquid crystal display panel, displays the user interface screen for users. The CPU 12 controls the whole of the operation display 1. The display controller 13 draws information and the user interface screen on the display 11 by converting them into image formats under the control of the CPU 12.

The position acquisition module 15 acquires positional coordinates where a touch is made on the display 11. The position acquisition module 15 comprises a touch sensor film attached on a surface of the display 11. The touch sensor film comprises sensors arranged in the X-axis and the Y-axis directions. When a user touches the screen with the user's hand or finger or a mobile terminal, the touch sensor film detects the touch and outputs a detection signal including the positional coordinates of the touch position to the position acquisition IF 16. The touch is not limited to the touch actually made. A state in which an object nearly touches the display may be regarded as the touch.

The position acquisition IF 16 outputs the detection signal (including the positional coordinates detected by the touch sensor film) input from the position acquisition module 15 to the CPU 12.

The position acquisition module 15 may be an optical touch sensor. The optical touch sensor may detect the presence of an object by detecting whether light is transmitted or blocked, or using the image captured by a camera.

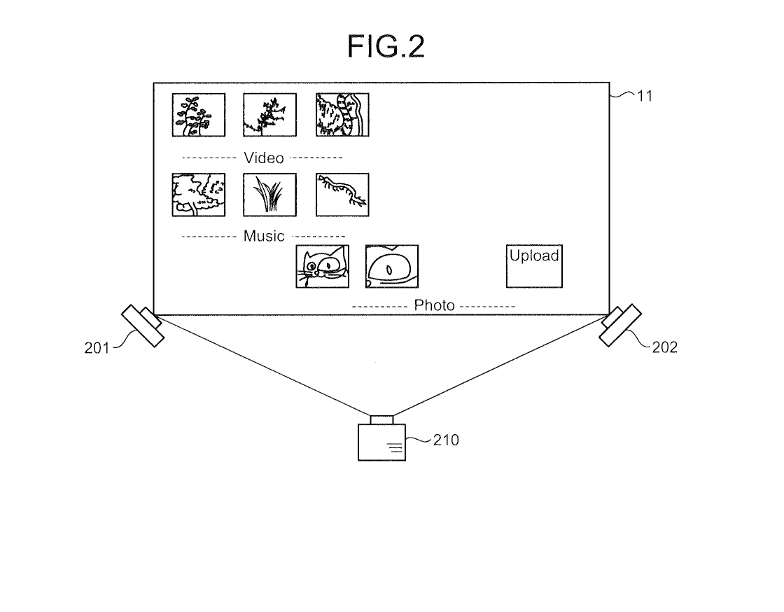

FIG. 2 is a schematic diagram illustrating a modification example in which images are displayed on a wall surface using a projector 210 as the display 11. In the example illustrated in FIG. 2, optical touch sensors 201 and 202 are comprised as the position acquisition modules for detecting positions where touches are made on the wall surface on which the images are projected. In such modification example, the same effect as the embodiment can be achieved by performing the same processing as the embodiment. The position detection modules are not limited to the optical touch sensors 201 and 202. Cameras may be used. In the same manner as the embodiment, the touch sensor film may be used.

Referring back to FIG. 1, the communication IF 17 is the interface that exchanges data between the operation display 1 and other terminals. For example, the communication IF 17 exchanges data with mobile terminals using Bluetooth (registered trademark) or a wireless local area network (LAN), and performs Internet communication using the wireless LAN.

The storage 14, which is composed of storage media such as a read only memory (ROM) and a random access memory (RAM) capable of storing information, comprises an icon storage 21, a program group 22, and a terminal cooperation program 23.

The icon storage 21 stores therein image data of icons displayed on the user interface screen, programs that perform processing when touches are made on the icons, and positional information indicating display positions of the icons on the user interface screen of the display 11 so as to correspond to each other.

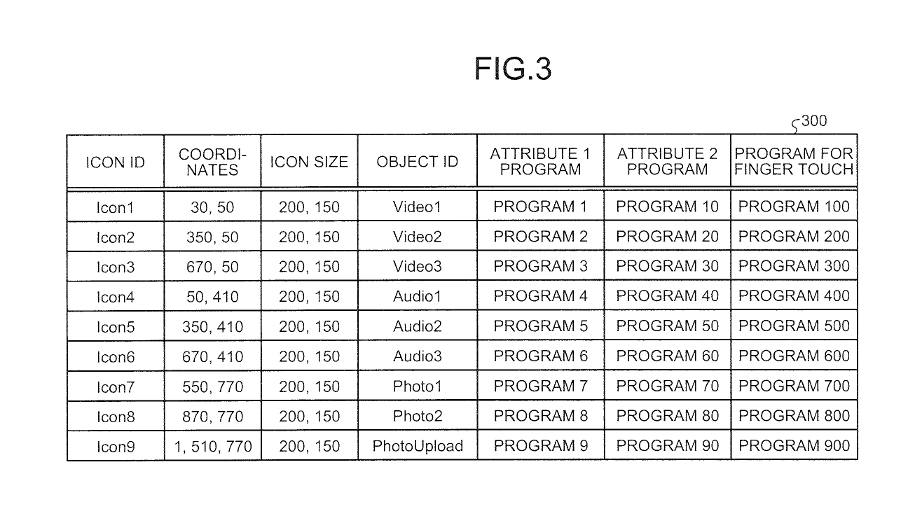

FIG. 3 is a schematic diagram illustrating a data structure of an icon data table 300 stored in the icon storage 21. As illustrated in FIG. 3, the icon data table 300 stores therein an icon ID serving as identification information of a predetermined icon, (positional) coordinates as an example indicating a position of the icon displayed on the display 11, an icon size, an object ID designating image data used for the icon, and programs activated for each attribute of the terminals so as to correspond to each other in one record.

The image data used for the icon designated by the object ID is drawn at the position indicated by the (positional) coordinates on the display 11 under the control of the CPU 12. The icon data table 300 stores three types of programs as the programs activated when the icon is touched so as to correspond to the icon ID. They are an attribute 1 program that is activated when the terminal touched to the icon corresponds to attribute 1, an attribute 2 program that is activated when the terminal touched to the icon corresponds to attribute 2, and a program for a finger touch that is activated when an object other than the mobile terminal (e.g., a finger of a user) is touched to the icon.

The programs are not limited to the programs having different executable codes. The programs that pass different arguments are described as the different programs although they have the same executable codes. For example, the programs that activate a web browser and pass different uniform resource locators (URLs) from each other are different programs. For another example, message display programs that pass different messages are different programs.

Referring back to FIG. 1, the program group 22 stores therein the programs executed by the operation display 1. The programs include the attribute 1 program, the attribute 2 program, and the program for a finger touch.

The terminal cooperation program 23 comprises a communication controller 101, a detector 102, a determiner 103, and an activator 104. When a touch on the display 11 is detected, the terminal cooperation program 23 performs control to activate the program included in the program group 22.

The communication controller 101 establishes communication with the mobile terminal. The communication controller 101 receives from the mobile terminal attribute information indicating the attribute of the mobile terminal. The communication controller 101 receives an acceleration detection signal indicating acceleration generated in the mobile terminal.

The detector 102 detects the touch on the display 11 based on the detection signal input from the position acquisition module 15 through the position acquisition IF 16. The detector 102 acquires the positional coordinates of the position where the touch is made on the display 11 from the input detection signal including the positional coordinates.

The determiner 103 identifies the mobile terminal touched to the display 11 based on the time when the detector 102 detects the touch and the time when the communication controller 101 receives the acceleration detection signal. In the embodiment, the determiner 103 determines the mobile terminal serving as a transmission origin of the acceleration detection signal as the terminal touched to the display 11 when a difference between the time when the detector 102 detects the touch and the time when the communication controller 101 receives the acceleration detection signal is within a predetermined threshold. The threshold is determined in accordance with the embodiment.

The determiner 103 identifies a program to be activated based on the attribute of the identified mobile terminal, the icon data table 300, and the positional coordinates included in the acceleration detection signal. As a result, the program corresponding to the attribute of the mobile terminal can be activated.

The activator 104 activates the program identified by the determiner 103. For example, when the mobile terminal corresponds to attribute 1, the activator 104 activates the program corresponding to attribute 1. The positional coordinates of the position where the mobile terminal is touched to the display 11 are not always required to be equal to or overlap with the positional coordinates corresponding to the icon. For example, the activator 104 may activate the program corresponding to the icon when the distance between both positional coordinates is within a predetermined value.

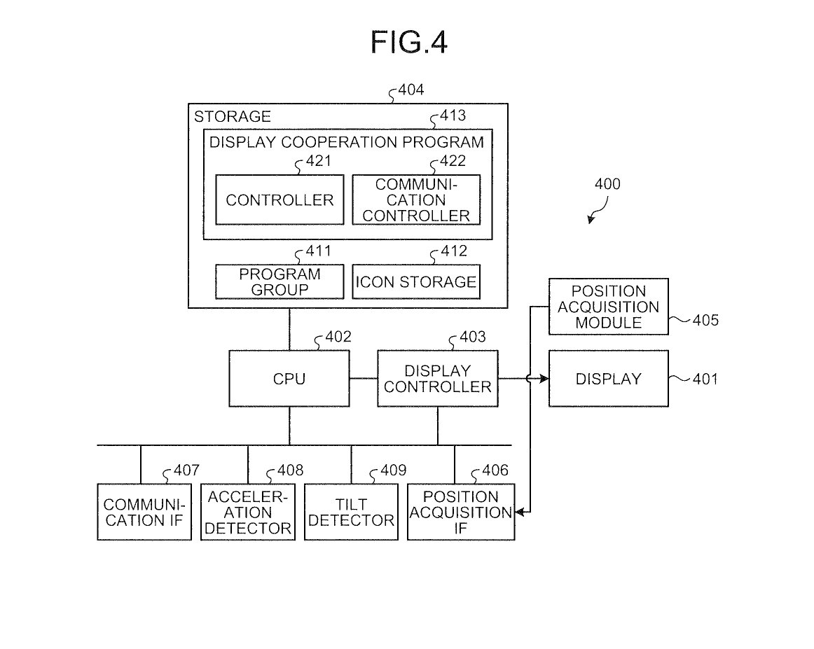

FIG. 4 is a hardware structural view of a mobile terminal 400 in the embodiment. As illustrated in FIG. 4, the mobile terminal 400 comprises a display 401, a CPU 402, a display controller 403, a storage 404, a position acquisition module 405, a position acquisition IF 406, a communication IF 407, an acceleration detector 408, and a tilt detector 409.

The descriptions of the display 401, the CPU 402, the display controller 403, the position acquisition module 405, the position acquisition IF 406, and the communication IF 407 comprised in the mobile terminal 400 are omitted because they perform processing in the same manner as that performed by the display 11, the CPU 12, the display controller 13, the position acquisition module 15, the position acquisition IF 16, and the communication IF 17 comprised in the operation display 1. The display of the mobile terminal 400 in the embodiment has a smaller screen size than that of the display 11 of the operation display 1 in the following description.

The acceleration detector 408 detects acceleration from an acceleration sensor provided to the mobile terminal 400 and outputs acceleration information to the CPU 402.

The tilt detector 409 detects a tilt from a tilt sensor provided to the mobile terminal 400 and outputs tilt information to the CPU 402.

The storage 404, which is composed of storage media such as a ROM and a RAM capable of storing information, comprises an icon storage 412, a program group 411, and a display cooperation program 413.

The icon storage 412 stores therein image data of icons displayed on the user interface screen, programs that perform processing when touches are made on the icons, and positional information indicating display positions of the icons on the user interface screen of the display 401 so as to correspond to each other, in the same manner as the icon storage 21 of the operation display 1.

The program group 411 stores therein programs with which the mobile terminal 400 can reproduce and display data (e.g., moving image data, voice data, and photograph data).

The display cooperation program 413, which is a resident program in the mobile terminal 400, comprises a controller 421 and a communication controller 422, and performs control to cooperate with the operation display 1.

The controller 421 sets the data reproduced and displayed by the program of the program group 411 as a transmission target when data is transmitted to the operation display 1.

The communication controller 422 performs control to transmit the attribute information indicating the attribute of the mobile terminal 400 when communication is established between the mobile terminal 400 and the operation display 1. The communication controller 422 performs control to transmit the data set by the controller 421 when performing control to transmit data to the operation display 1.

The attribute information comprises a model name of the mobile terminal, a type of the terminal such as a camera or an audio player, a format of set data, the tilt information of the terminal detected by the tilt detector 409, and terminal authentication information.

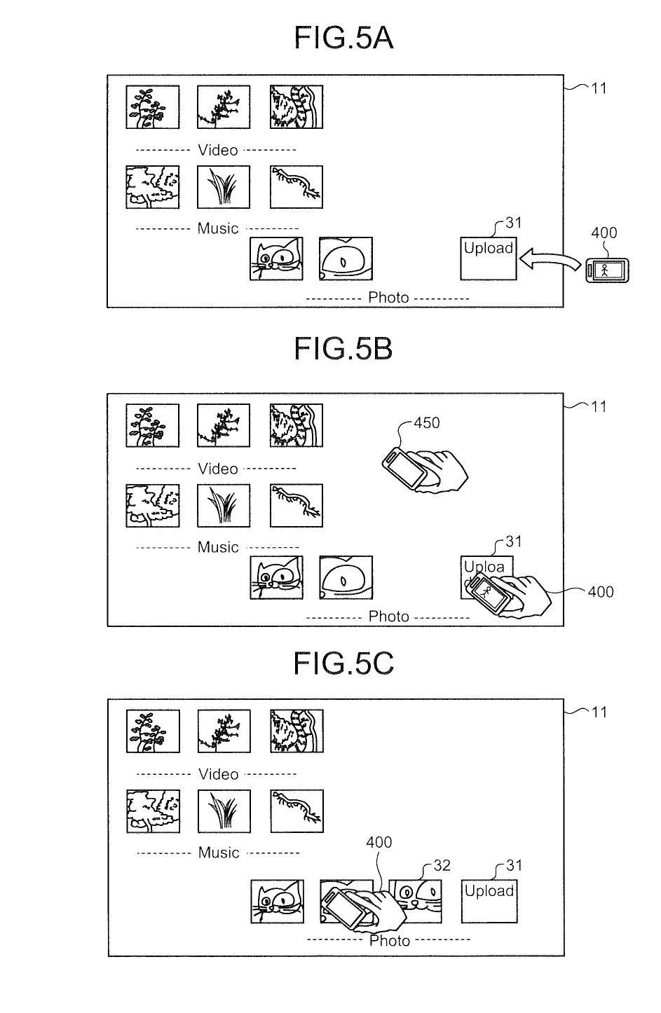

FIGS. 5A, 5B, and 5C are schematic diagrams illustrating an example of the user interface screen when the operation display 1 in the embodiment executes the terminal cooperation program 23. As illustrated in FIG. 5A, the display 11 of the operation display 1 displays three types of moving image data, three types of music data, and two types of photograph data stored in the storage 14 with the respective different types of icons. In addition, the display 11 displays an uploading icon 31 that uploads the data selected by the mobile terminal. In FIG. 5A, the program capable of reproducing and displaying the data to be uploaded (e.g., moving image data) has been activated and the selection of the data has been completed by the mobile terminal 400.

A case is described where a touch is made on the user interface screen of the display 11 using the mobile terminal 400 out of a plurality of mobile terminals, i.e., the mobile terminal 400 and a mobile terminal 450. The operation display 1 in the embodiment identifies the mobile terminal 400 as a terminal to cooperate with and uploads the set moving image data. Operation performed in this case is described below.

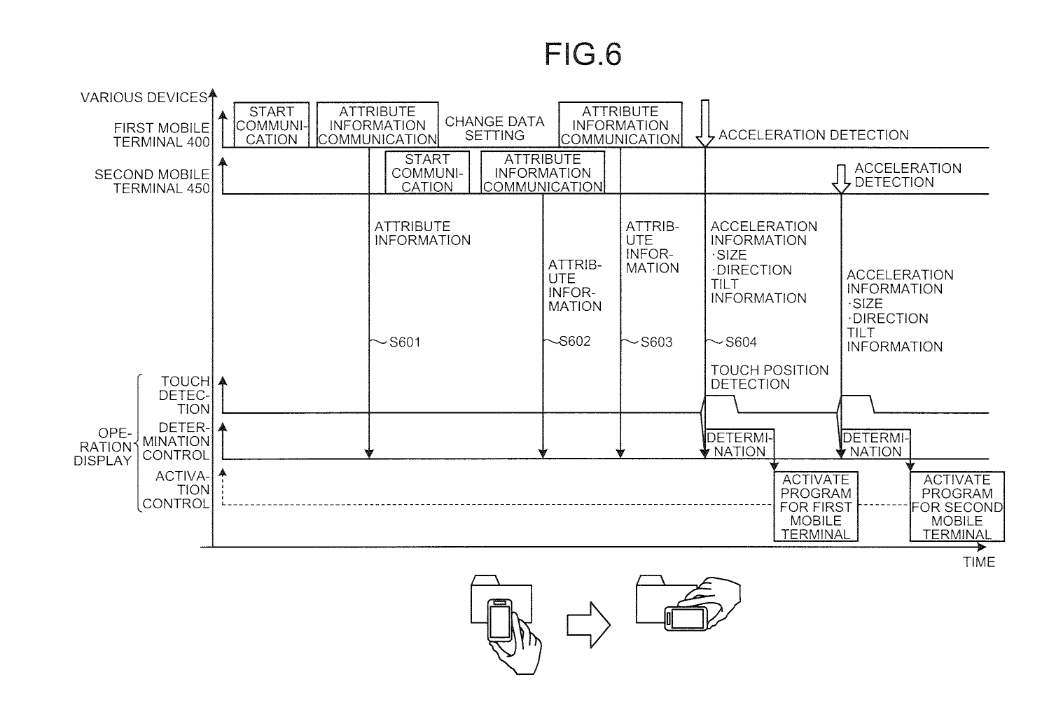

FIG. 6 is a schematic diagram illustrating a timing chart when cooperative processing is performed between the operation display 1 and the mobile terminal 400.

Approaching the operation display 1, the mobile terminals 400 and 450 start to communicate with the operation display 1. In the embodiment, the communication is performed using a wireless LAN. Entering the same LAN area as the operation display 1, the mobile terminals 400 and 450 acquire the IP addresses.

The operation display 1 receives the respective pieces of attribute information indicating the terminal attributes from the respective mobile terminals 400 and 450 (S601 and S602).

In the example illustrated in FIG. 5B, the first mobile terminal 400 is put on the uploading icon 31 whereas the second mobile terminal 450 is at a position away from the display 11 of the operation display 1. The second mobile terminal 450, which can communicate with the operation display 1, may not be near the operation display 1, but may be in a bag of a person other than the user, for example. In this case, the operation display 1 receives attribute information of both the first mobile terminal 400 and the second mobile terminal 450.

Referring back to FIG. 6, the attribute information is transmitted by the first mobile terminal 400 and the second mobile terminal 450 in the embodiment at every change in setting of the first mobile terminal 400 and the second mobile terminal 450 (e.g., at every change in set data) (e.g., S603). The embodiment does not limit the timing of transmitting the attribute information. For example, the attribute information may be periodically transmitted to the operation display 1.

When the first mobile terminal 400 and the second mobile terminal 450 receive a response that the attribute information is appropriately acquired after the operation display 1 receives the attribute information of the first mobile terminal 400 and the second mobile terminal 450, the first mobile terminal 400 and the second mobile terminal 450 may display a message that cooperative operations are ready to be performed with the operation display 1 on the respective screens of the terminals.

At the moment when the first mobile terminal 400 is put on the uploading icon 31, the communication controller 422 of the first mobile terminal 400 transmits the acceleration information detected by the acceleration detector 408 to the operation display 1 as the acceleration detection signal (S604).

Meanwhile, the detector 102 of the operation display 1 detects that an object is touched to the vicinity of the uploading icon 31 or in a position very close to the uploading icon 31 based on the detection signal (including the positional coordinates) transmitted from the position acquisition module 15.

The determiner 103 determines that the first mobile terminal 400 having transmitted the acceleration detection signal is touched to the display 11 if the time when the detection signal is received is very close to the time when the acceleration detection signal is received from the first mobile terminal 400 (the difference in time is within a predetermined threshold), and identifies the first mobile terminal 400 as a cooperative target.

The determiner 103 refers to the icon data table 300 and identifies the program to be executed out of the programs associated with the uploading icon 31 based on the attribute of the first mobile terminal 400.

The activator 104 activates the program identified by the determiner 103. The activated program exchanges data with the first mobile terminal 400 through the communication IF 17.

Regarding the execution of the program, the operation of the program may be changed or the program may be changed to another one in accordance with a value of the acceleration indicated by the received acceleration detection signal. For example, when the value of the acceleration is small because the mobile terminal 400 is gently put on the display 11, a data transfer speed is set to 1 Mbit/sec whereas when the value of the acceleration is larger because the mobile terminal 400 is strongly put on the display 11, data is exchanged at a faster data transfer speed of more than 1 Mbit/sec.

When the acceleration is very large because the mobile terminal 400 is more strongly put on the display 11, the activator 104 may change the program to be activated to a program that displays a message, such as “please touch the display more gently, because a heavy touch causes failures”, without performing the data transfer.

When the mobile terminal 450 is put on the uploading icon 31 after the placement of the mobile terminal 400, the detector 102 detects the touch of the mobile terminal 400 by receiving the detection signal (including the positional coordinates) through the position acquisition module 15. The detector 102 acquires the positional coordinates where the touch is made. The communication controller 101 receives the acceleration detection signal from the mobile terminal 450. The determiner 103 identifies the mobile terminal 450, which touches the uploading icon 31, and performs the same processing as when the mobile terminal 400 is touched.

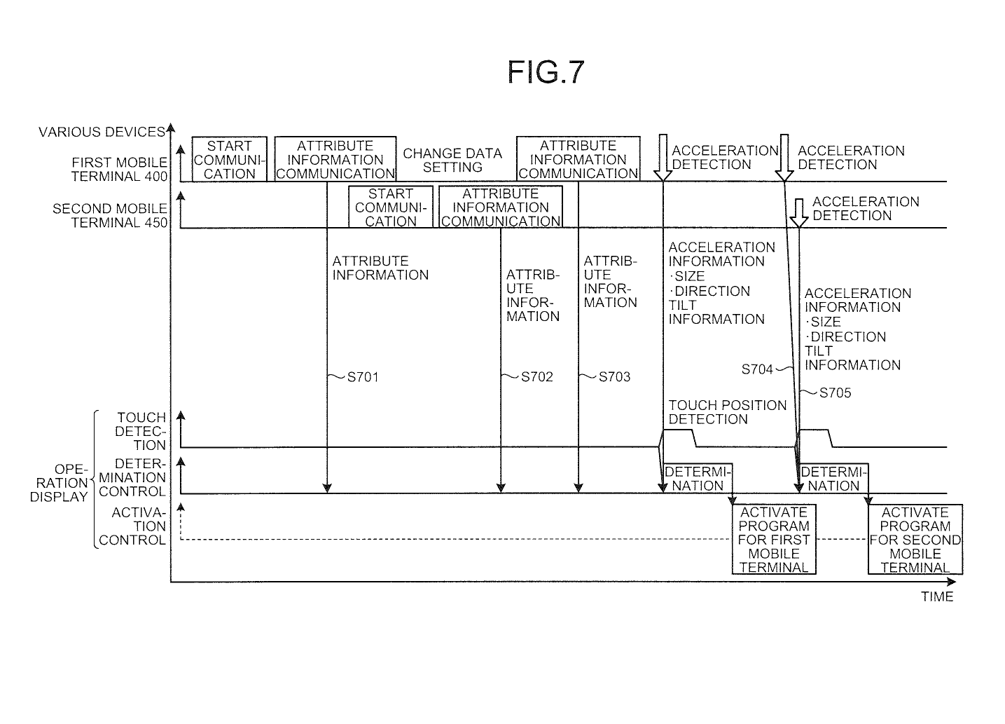

FIG. 7 illustrates a case where the time when the acceleration detection signal is received from the first mobile terminal 400 and the time when the acceleration detection signal is received from the second mobile terminal 450 are very close to the time when the detection signal is received (the difference in time is within a threshold). In the example illustrated in FIG. 7, the communication starts and the attribute information is transmitted in the same manner as the example illustrated in FIG. 6 (S701, S702, and S703).

Thereafter, the communication controller 101 of the operation display 1 receives the acceleration detection signal from the first mobile terminal 400 and the acceleration detection signal from the second mobile terminal 450 at nearly the same timing (S704 and S705). In other words, within a predetermined threshold after the detector 102 detects the touch, the communication controller 101 receives the acceleration detection signals from the first mobile terminal 400 and the second mobile terminal 450.

For example, a case may occur where a timing when the mobile terminal 400 is touched to the display 11 of the operation display 1 is nearly the same as the timing when acceleration is generated in the mobile terminal 450 in a bag due to the collision of the bag with something. As another example, a case may occur where a timing when a user strongly hits the screen of the second mobile terminal 450 in a totally different operation from that of the first mobile terminal 400 coincides with the timing when the first mobile terminal 400 is touched to the display 11 of the operation display 1.

In such a case where the determiner 103 identifies a plurality of terminals as the terminals touched to the display 11, for preventing the control of exchanging data with a wrong terminal, a message such as “please touch again” may be displayed on the screen without performing the exchange of data with the identified mobile terminals 400 and 450, so as to prompt a user to touch the screen with the terminal again. As a result, data can be exchanged with the desired mobile terminal of the user.

When the determiner 103 identifies a plurality of terminals as the terminals touched to the display 11, the countermeasure is not limited to the prompting of a re-touch. It may be regarded that both terminals are touched to the display 11, and the respective corresponding programs may be executed for both mobile terminals. In this way, operation is determined in accordance with the embodiment.

FIG. 5C illustrates an example of the screen after the uploading is completed. In the example of the screen illustrated in FIG. 5C, an icon 32 that represents data transmitted to the operation display 1 from the first mobile terminal 400 is additionally displayed next to the uploading icon 31. The program activated by the activator 104 determines the type of uploaded data so as to identify the data as any of moving image, music, and photograph, and provides an appropriate icon to the data. A dedicated folder such as an image folder or a music folder may be designated as a data storage folder serving as a storage destination in accordance with the type of data.

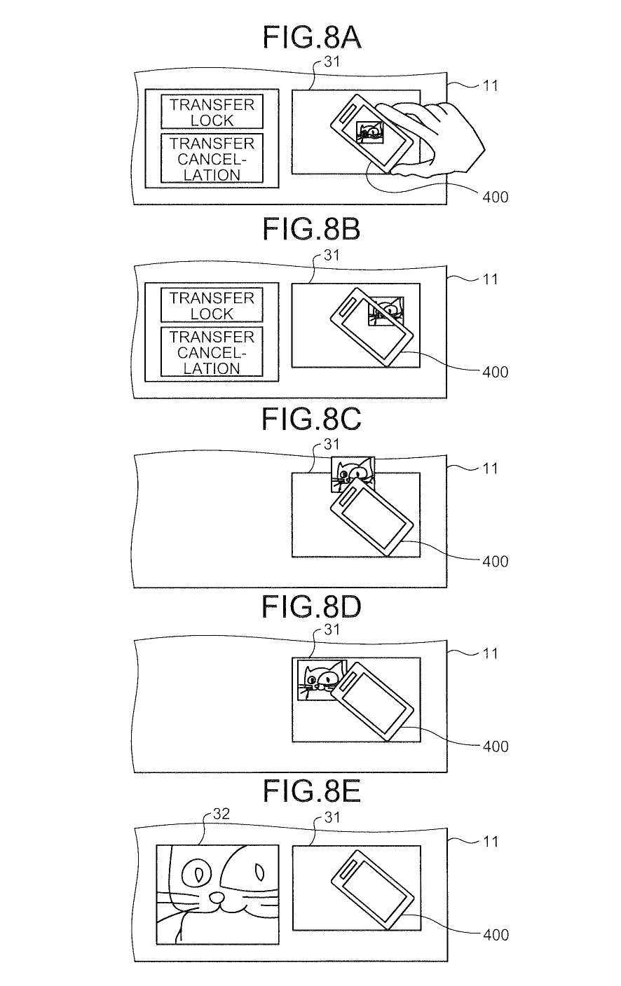

As an example of the user interface screen when such data is transferred is illustrated in FIGS. 8A to 8E. FIGS. 8A to 8E illustrate a transition of the example of the screen displayed when the first mobile terminal 400 is touched to the display 11. As illustrated in FIG. 8A, photograph data stored in the first mobile terminal 400 is displayed on the screen of the first mobile terminal 400 as an icon, for example. When the first mobile terminal 400 is touched to the display 11 of the operation display 1, transfer of the data starts.

As illustrated in FIGS. 8B to 8D, a part of the icon is displayed on the screen of the display 11 and the other part of the icon is displayed on the screen of the first mobile terminal 400 as the transfer of the data progresses. The part corresponds to a proportion of the transferred data amount to the total data amount while the other part corresponds to a proportion of the untransferred data amount to the total data amount. The position of the icon displayed on the display 11 of the operation display 1 during the data transfer is determined based on the positional coordinates of the first mobile terminal 400 acquired by the position acquisition module 15. The display 11 displays the icon such that the icon displayed on the display screen of the first mobile terminal 400 and the icon displayed on the display 11 are viewed as a single icon by combining the two icons. As illustrated in FIG. 8E, the display 11 displays the icon 32 of the data next to the uploading icon 31 when the transfer of the data is completed. The program determines the type of the data and displays the icon at the position corresponding to the type of the data, i.e., any of moving image, music, and photograph. Then, the program ends the processing relating to the data transfer.

In this way, the terminal cooperation program 23 controls the display 11 to display the transition of the transfer of data from the first mobile terminal 400, i.e., the progress of transmitting data from the first mobile terminal 400 to the operation display 1, so as to make it appear as though the icon 32 of the data enters the display 11. As a result, a user can know the transmission progress.

When the touch of the first mobile terminal 400 on the display 11 is detected, the terminal cooperation program 23 may not start data transfer immediately, but may display a dialogue for confirmation on the first mobile terminal 400 to request a user to confirm the operation. As a result, if the result of the determination whether the first mobile terminal 400 made contact is wrong, this request for confirmation can prevent the data transfer against the will of the user.

When the operation display 1 transmits data to the first mobile terminal 400, the display cooperation program 413 of the first mobile terminal 400 displays a part, which corresponds to a proportion of the data amount having been transferred or the transferred data amount to the total data amount, of the icon on the screen of the display 401. The display 11 of the operation display 1 displays the other part (the part that is not displayed on the mobile terminal), which corresponds to a proportion of the untransferred data amount to the total data amount, of the icon based on the positional coordinates acquired by the position acquisition module 15.

The operation display 1 may receive information of the pixel density or resolution and the size of the screen of the first mobile terminal 400, and display the icon by adjusting the size of the icon. Alternatively, the first mobile terminal 400 may display the icon by adjusting the size of the icon when the operation display 1 transmits information of the pixel density or resolution and the screen size of the operation display 1 to the mobile terminal. As a result, the icon can be displayed on the first mobile terminal 400 and the operation display 1 in the same size or nearly the same size.

The operation display 1 may acquire information of a postural direction of the first mobile terminal 400 and display the icon in the direction corresponding to the direction indicated by the information. Such processing may be performed by the processing relating to FIG. 5B. That is, when the first mobile terminal 400 is put on the uploading icon 31 and the data transfer starts, the first mobile terminal 400 and the operation display 1 may display the icons in the same or nearly the same size.

When the acceleration detection signal from the first mobile terminal 400 is not received although the touch to the display 11 is detected, the determiner 103 determines that an object other than the mobile terminal (e.g., hand or finger) is touched to the icon, and the reproduction and display of the data represented by the icon (e.g., moving image data or photograph data) are performed on the display 11.

When the first mobile terminal 400 is moved away from the display 11 in the data transfer, the data transfer between the operation display 1 and the first mobile terminal 400 is canceled. In this way, a user can intuitively dictate the cancellation of the data transfer without performing any specific operation to cancel the data transfer. The display 11 may display dialogues such as “transfer lock (i.e., transfer is continued)” and “transfer cancellation (i.e., transfer is canceled)” illustrated in FIGS. 8A and 8B before the start of the transfer or during the transfer. When the operation display 1 has received no selection corresponding to the dialogues, the data transfer is canceled by moving the first mobile terminal 400 away from the display 11 after the start of the transfer. When the selection of “transfer lock” has been received, the data transfer continues although the first mobile terminal 400 is moved away from the display 11. As a result, a user does not need to continue to touch the first mobile terminal 400 to the display 11 during the data transfer.

When the operation display 1 receives the selection of “transfer cancellation”, the data transfer between the operation display 1 and the mobile terminal 400 is canceled. That is, when the selection of “transfer lock” is received, the data transfer is not canceled although the first mobile terminal 400 is moved away from the display 11 whereas the data transfer can be canceled when the selection of “transfer cancellation” is received from a user. This makes it possible for a user to cancel the data transfer by selecting “transfer cancellation” when the user wants to cancel the data transfer although the user has selected “transfer lock”.

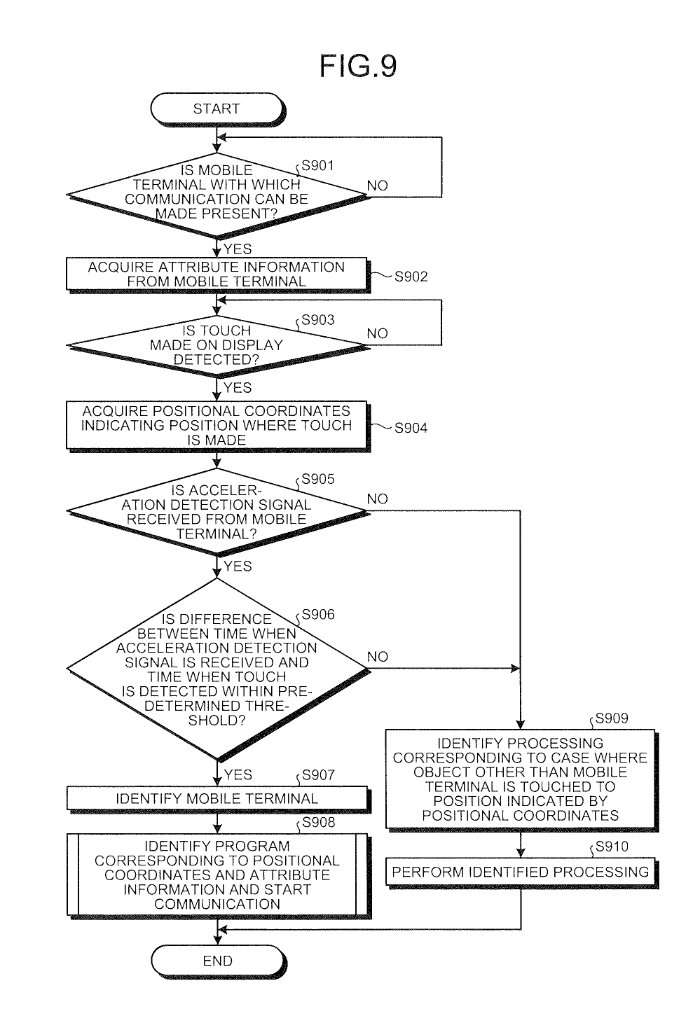

Processing is described below that covers from the identification of a program to the start of communication in the operation display 1 in the embodiment. FIG. 9 is a flowchart illustrating a procedure of the above-described processing in the operation display 1 in the embodiment.

The communication IF 17 detects whether a mobile terminal is present with which communication can be made (S901). If no available mobile terminal is detected (No at S901), the communication IF 17 continues the detection until a mobile terminal is detected with which communication can be made. If the communication IF 17 detects mobile terminals with which communication can be made (Yes at S901), the communication IF 17 starts communication with the respective detected mobile terminals. The determiner 103 of the terminal cooperation program 23 acquires the attribute information of the respective mobile terminals through the communication IF 17 (S902).

The detector 102 determines whether a touch is made on the display 11 based on the detection signal from the position acquisition module 15 (S903). If the detector 102 determines that a touch is made on the display 11 (Yes at S903), the detector 102 acquires the positional coordinates where the touch is made from the detection signal including the positional coordinates (S904). If the detector 102 determines that no touch is made on the display 11 (No at S903), the processing at S903 is repeated.

The communication controller 101 determines whether the acceleration detection signal is received from the mobile terminal through the communication IF 17 (S905). If no acceleration detection signal is received (No at S905), the determiner 103 regards the touch as a touch made by a finger of a human and not by a mobile terminal, and identifies the processing (program) corresponding to a case where the mobile terminal is touched to the position indicated by the positional coordinates (S909). The activator 104 executes the identified processing (program) (S910). For example, the identified processing is a reproduction and display of data (moving image data, music data, or photograph data) corresponding to the icon at the touch position. When it is determined that a finger is touched to the display 11 and not a mobile terminal as described above, the data may be reproduced on the display 11 instead of being transferred.

If the communication controller 101 receives the acceleration detection signal (Yes at S905), the determiner 103 determines whether the difference between the time when the touch is detected based on the detection signal and the time when acceleration is generated in the mobile terminal, which is determined based on the acceleration detection signal, is within a predetermined threshold, in other words, the occurrences are close in time (S906). If the difference in time is not within the predetermined threshold (No at S906), the processing proceeds to step S909.

If the determiner 103 determines that the difference is within the predetermined threshold (Yes at S906), the determiner 103 regards the mobile terminal having transmitted the acceleration detection signal used for the determination as the mobile terminal touched to the display 11 and identifies the mobile terminal as the target of exchanging data (S907).

The determiner 103 identifies the positional coordinates where the touch is made and the program corresponding to the attribute information of the identified mobile terminal. The activator 104 activates the identified program. As a result, communication starts between the operation display 1 and the mobile terminal (S908).

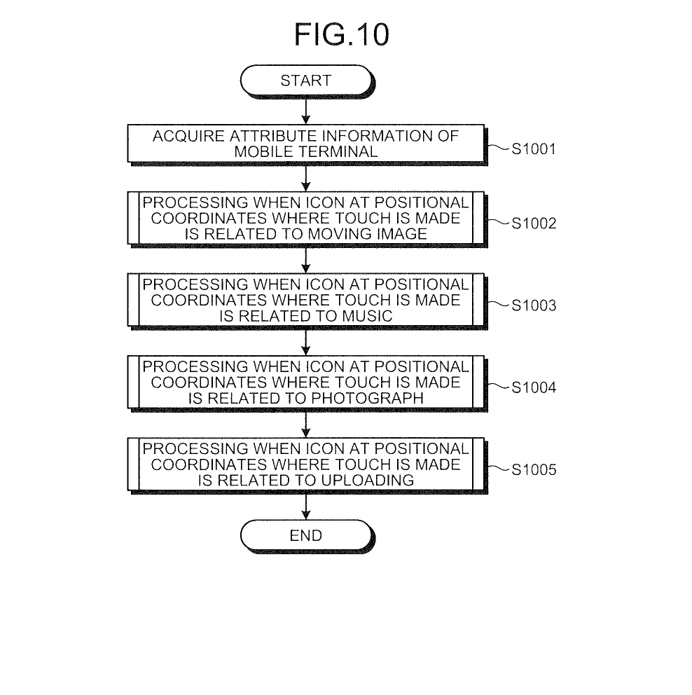

At S908, processing is performed in accordance with the attribute information of the mobile terminal. At S908, the attribute information of the mobile terminal may be acquired again. The processing at S908 in the embodiment is described below, which covers from the identification of the program to the start of the communication. FIG. 10 is a flowchart illustrating a procedure of the above-described processing in the operation display 1 in the embodiment.

The determiner 103 acquires the attribute information of the mobile terminal identified as the target of exchanging data (S1001). Examples of the information in the attribute information include applicable data formats, a display screen size, executable functions, and communication schemes. The acquired attribute of the mobile terminal is stored. The determiner 103 may acquire the attribute information through the communication IF 17 from a network (including the Internet) or preliminarily store the attribute in the operation display 1 as a database.

The determiner 103 and the activator 104 perform processing when the icon at the positional coordinates where the touch is made (or at a position near the touch position) is related to a moving image (S1002). For example, when a program for transferring a moving image file to the mobile terminal is activated, the resolution of the moving image is converted into a size corresponding to the screen size of the mobile terminal serving as the transfer destination in accordance with the attribute, such as whether the screen size of the mobile terminal is 1920×1080 or 640×480, and thereafter the transfer is performed.

The determiner 103 and the activator 104 perform processing when the icon at the positional coordinates where the touch is made (or at a position near the touch position) is related to music (S1003). For example, when a program for transferring a music file to the mobile terminal, the music file is converted into a file format executable by the mobile terminal in accordance with the attribute information, such as whether the mobile terminal can reproduce a music file in a moving picture experts group-1 (MPEG-1) audio layer 3 (MP3) format, or in an advanced audio coding (AAC) format.

The determiner 103 and the activator 104 perform processing when the icon at the positional coordinates where the touch is made (or at a position near the touch position) is related to a photograph (S1004).

The determiner 103 and the activator 104 perform processing when the icon at the positional coordinates where the touch is made (or at a position near the touch position) is related to uploading (S1005).

As described above, when the touch is made by the mobile terminal, the conversion processing is performed in accordance with the data format, and thereafter the transfer is performed. The communication scheme for transferring data may be changed based on the attribute, such as whether the mobile terminal serving as the transfer destination can communicate using a wireless LAN or Bluetooth (registered trademark). When data is transferred, the following manner may be used so as to cause a user to visually perceive that the data is being transferred. Size information indicating the whole size of the mobile terminal is acquired, an image of a terminal having a shape corresponding to that of the mobile terminal is drawn on the display 11 based on the acquired size information of the mobile terminal, and a path of the data transfer executed between the drawn image of the mobile terminal and the other user interface is displayed.

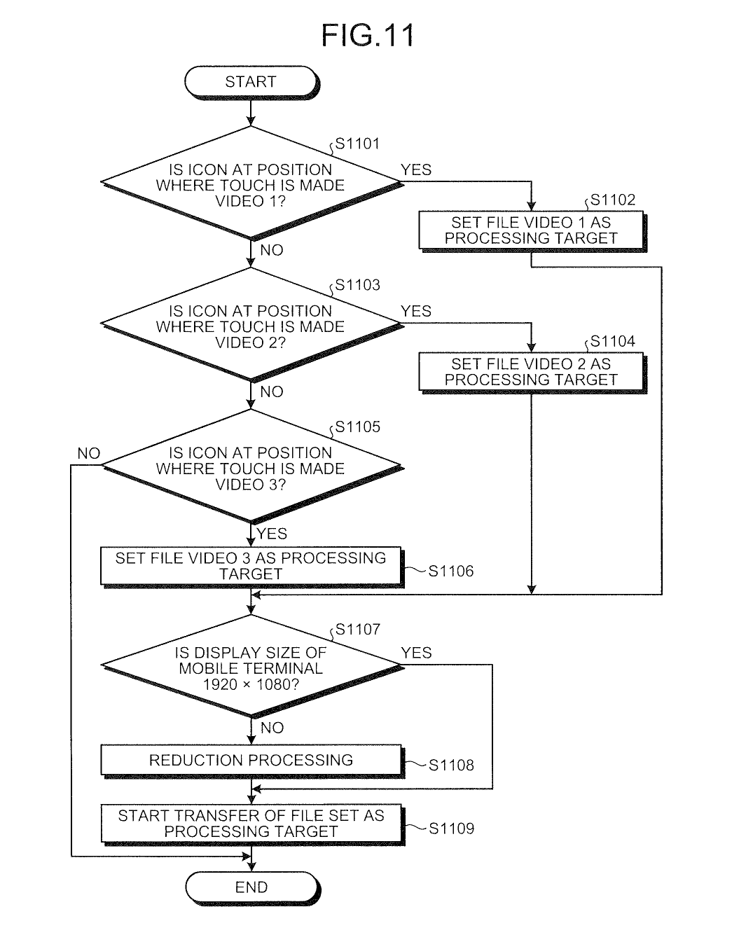

The specific processing at S1002 is described below. FIG. 11 is a flowchart illustrating a procedure of processing in the operation display 1 in the embodiment when the icon to which the mobile terminal is touched is related to a moving image.

The determiner 103 determines whether the icon at the touch position corresponds to a file Video1 based on the positional coordinates included in the detection signal (S1101). If it is determined that the icon corresponds to file Video1 (Yes at S1101), the determiner 103 sets the file Video1 as the processing target (S1102). Thereafter, the processing proceeds to S1107.

If the determiner 103 determines that the icon at the touch position does not correspond to the file Video1 (No at S1101), the determiner 103 determines whether the icon at the touch position corresponds to a file Video2 (S1103). If it is determined that the icon corresponds to the file Video2 (Yes at S1103), the determiner 103 sets the file Video2 as the processing target (S1104). Thereafter, the processing proceeds to S1107.

If the determiner 103 determines that the icon at the touch position does not correspond to the file Video2 (No at S1103), the determiner 103 determines whether the icon at the touch position corresponds to a file Video3 (S1105). If it is determined that the icon corresponds to the file Video3 (Yes at S1105), the determiner 103 sets the file Video3 as the processing target (S1106). Thereafter, the processing proceeds to S1107. If it is determined that the icon does not correspond to file Video3 (No at S1105), no processing relating to a moving image is performed.

After S1102, S1104, or S1106, the determiner 103 determines whether the moving image data displayed in a display size of 1920×1080 can be reproduced by the mobile terminal serving as the transmission destination of the moving image data based on the acquired attribute information (S1107). For example, the mobile terminal has two types of screen sizes, i.e., 1920×1080 and 640×480.

If the determiner 103 determines that the mobile terminal can reproduce the moving image displayed in a display size of 1920×1080 (Yes at S1107), the processing proceeds to S1109 because the moving image is transmitted without any change. If the determiner 103 determines that the mobile terminal cannot reproduce the moving image displayed in a display size of 1920×1080 (No at S1107), the activator 104 activates a reduction program that reduces the moving image data and the reduction program performs reduction processing to reduce the moving image data so as to be displayed in a display size of 640×480 (S1108).

After S1107 and S1108, the activator 104 activates a moving image transfer program that transfers the moving image data and the moving image transfer program starts transferring the file set as the processing target (S1109).

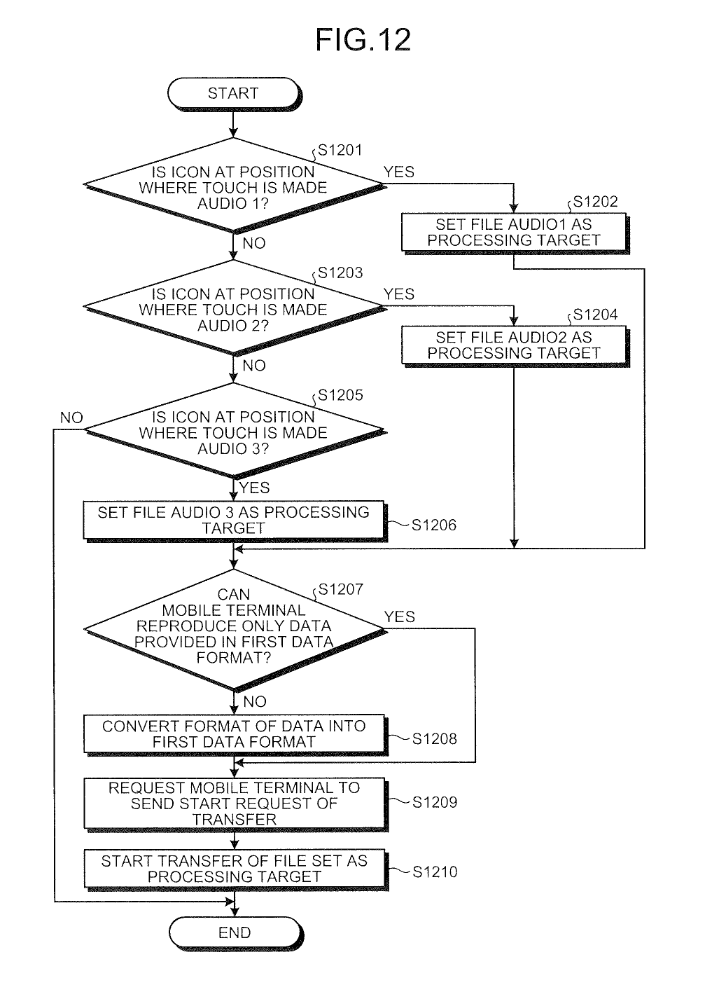

The specific processing at S1003 of FIG. 10 is described below. FIG. 12 is a flowchart illustrating a procedure of processing in the operation display 1 in the embodiment when the icon to which the mobile terminal is touched is related to music.

The determiner 103 determines whether the icon at the touch position corresponds to a file Audio1 based on the positional coordinates included in the detection signal (S1201). If it is determined that the icon corresponds to the file Audio1 (Yes at S1201), the determiner 103 sets the file Audio1 as the processing target (S1202). Thereafter, the processing proceeds to S1207.

If the determiner 103 determines that the icon at the touch position does not correspond to the file Audio1 (No at S1201), the determiner 103 determines whether the icon at the touch position corresponds to a file Audio2 (S1203). If it is determined that the icon corresponds to the file Audio2 (Yes at S1203), the determiner 103 sets the file Audio2 as the processing target (S1204). Thereafter, the processing proceeds to S1207.

If the determiner 103 determines that the icon at the touch position does not correspond to the file Audio2 (No at S1203), the determiner 103 determines whether the icon at the touch position corresponds to a file Audio3 (S1205). If it is determined that the icon corresponds to the file Audio3 (Yes at S1205), the determiner 103 sets the file Audio3 as the processing target (S1206). Thereafter, the processing proceeds to S1207. If it is determined that the icon does not correspond to the file Audio3 (No at S1205), no processing relating to music is performed.

After S1202, S1204, or S1206, the determiner 103 determines whether only data provided in a first data format (e.g., AAC) can be reproduced by the mobile terminal based on the acquired attribute information (S1207). The music data is provided in a plurality of data formats (e.g., AAC and MP3).

If the determiner 103 determines that the music data provided in another format can be reproduced in addition to the data provided in the first data format (No at S1207), the processing proceeds to S1209 because the music data is transmitted without any change. If the determiner 103 determines that the mobile terminal can reproduce only the music data provided in the first data format (Yes at S1207), the activator 104 activates a conversion program that converts the data format of the music data into the first data format and the conversion program performs converting processing to convert the format of the music data into the first data format (S1208).

After S1207 and S1208, the activator 104 activates a music transfer program that transfers the music data and the music transfer program requests the mobile terminal to send a start request of the transfer of the music data (S1209). Thereafter, the music transfer program starts transferring the file set as the processing target (S1210).

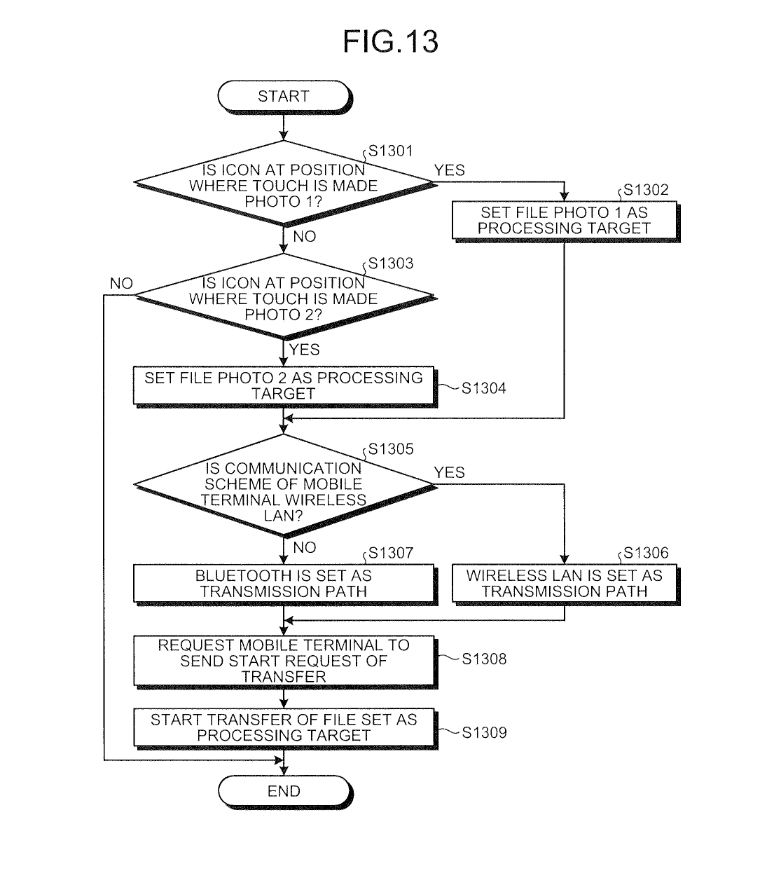

The specific processing at S1004 of FIG. 10 is described below. FIG. 13 is a flowchart illustrating a procedure of processing in the operation display 1 in the embodiment when the icon to which the mobile terminal is touched is related to a photograph.

The determiner 103 determines whether the icon at the touch position corresponds to a file Photograph1 based on the positional coordinates included in the detection signal (S1301). If it is determined that the icon corresponds to the file Photograph1 (Yes at S1301), the determiner 103 sets the file Photograph1 as the processing target (S1302). Thereafter, the processing proceeds to S1305.

If the determiner 103 determines that the icon at the touch position does not correspond to the file Photograph1 (No at S1301), the determiner 103 determines whether the icon at the touch position corresponds to a file Photograph2 (S1303). If it is determined that the icon corresponds to the file Photograph2 (Yes at S1303), the determiner 103 sets the file Photograph2 as the processing target (S1304). Thereafter, the processing proceeds to S1305. If it is determined that the icon does not correspond to the file Photograph2 (No at S1303), no processing relating to music is performed.

After S1302 or S1304, the determiner 103 determines whether the communication scheme of the mobile terminal is a wireless LAN based on the acquired attribute information (S1305). In the embodiment, the communication scheme is selected from two types of the wireless LAN and Bluetooth (registered trademark).

If the determiner 103 determines that communication can be performed using the wireless LAN (Yes at S1305), the wireless LAN is set as a transmission path (S1306). If the determiner 103 determines that communication cannot be performed using the wireless LAN (No at S1305), Bluetooth (registered trademark) is set as the transmission path (S1307).

The activator 104 activates a photograph transfer program that transfers the photograph data and the photograph transfer program requests the mobile terminal to send a start request of the transfer of the photograph data (S1308). Thereafter, the photograph transfer program starts the file (photograph data) set as the processing target (S1309).

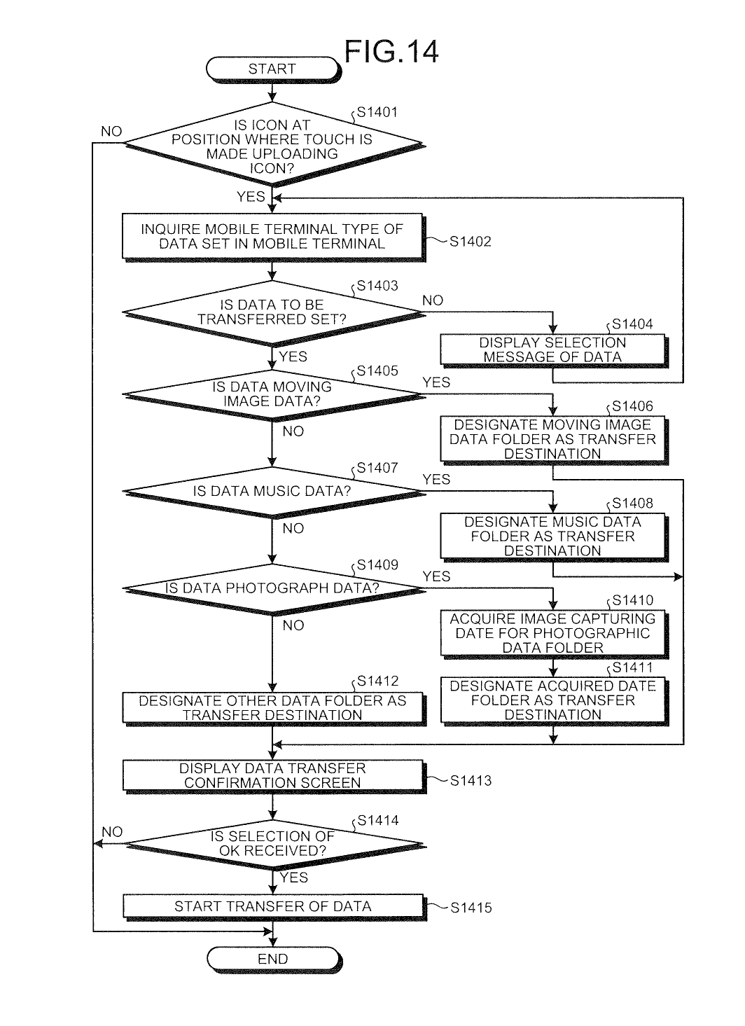

The specific processing at S1005 of FIG. 10 is described below. FIG. 14 is a flowchart illustrating a procedure of processing in the operation display 1 in the embodiment when the icon to which the mobile terminal is touched is related to uploading.

The determiner 103 determines whether the icon at the touch position is the uploading icon based on the positional coordinates included in the detection signal (S1401). If it is determined that the icon is not the uploading icon (No at S1401), the processing ends.

If it is determined that the icon is the uploading icon (Yes at S1401), the communication controller 101 inquires the mobile terminal on the type of data set in the mobile terminal as the transmission target (S1402).

The determiner 103 determines whether data to be transferred is set in the mobile terminal based on the inquiry result received by the communication controller 101 (S1403). If it is determined that no data is set to be transferred in the mobile terminal (No at S1403), the activator 104 activates a program for displaying a message, and the program displays a selection message such as “please touch this icon after data is selected by a device from which the data is transferred” on the display 11 (S1404). Thereafter, the processing proceeds to S1402.

If the determiner 103 determines that data to be transferred is set in the mobile terminal (Yes at S1403), the determiner 103 determines whether the set data to be transferred is moving image data (S1405). If it is determined that the set data is moving image data (Yes at S1405), the moving image transfer program is activated and the moving image transfer program designates a moving image data folder as the transfer destination (S1406). Thereafter, the processing proceeds to S1413.

If the determiner 103 determines that the set data is not moving image data (No at S1405), the determiner 103 determines whether the set data to be transferred is music data (S1407). If it is determined that the set data is music data (Yes at S1407), the music transfer program is activated and the music transfer program designates a music data folder as the transfer destination (S1408). Thereafter, the processing proceeds to S1413.

If the determiner 103 determines that the set data is not music data (No at S1407), the determiner 103 determines whether the set data to be transferred is photograph data (S1409). If it is determined that the set data is photograph data (Yes at S1409), the photograph transfer program is activated and the photograph transfer program acquires an image capturing date of the photograph data for a photograph data folder (S1410). The photograph transfer program designates the acquired date folder as the transfer destination (S1411). Thereafter, the processing proceeds to S1413.

If it is determined that the set data is not photograph data (No at S1409), the transfer program is activated and the transfer program designates the other data folder as the transfer destination (S1412). Thereafter, the processing proceeds to S1413.

The activated various transfer programs display respective data transfer confirmation screens (S1413). The respective transfer programs determine whether they individually receive the selection of “OK” (S1414). If the transfer program does not receive the selection of “OK” (No at S1414), the processing ends.

If the transfer program receives the selection of “OK”, data transfer starts between the operation display 1 and the mobile terminal (S1415).

In this way, data can be transferred by the processing procedure thus described. In the processing described above, the transfer programs are activated. The programs to be activated, however, are not limited to the transfer programs. For example, programs for electronic payment may be used as the programs to be activated.

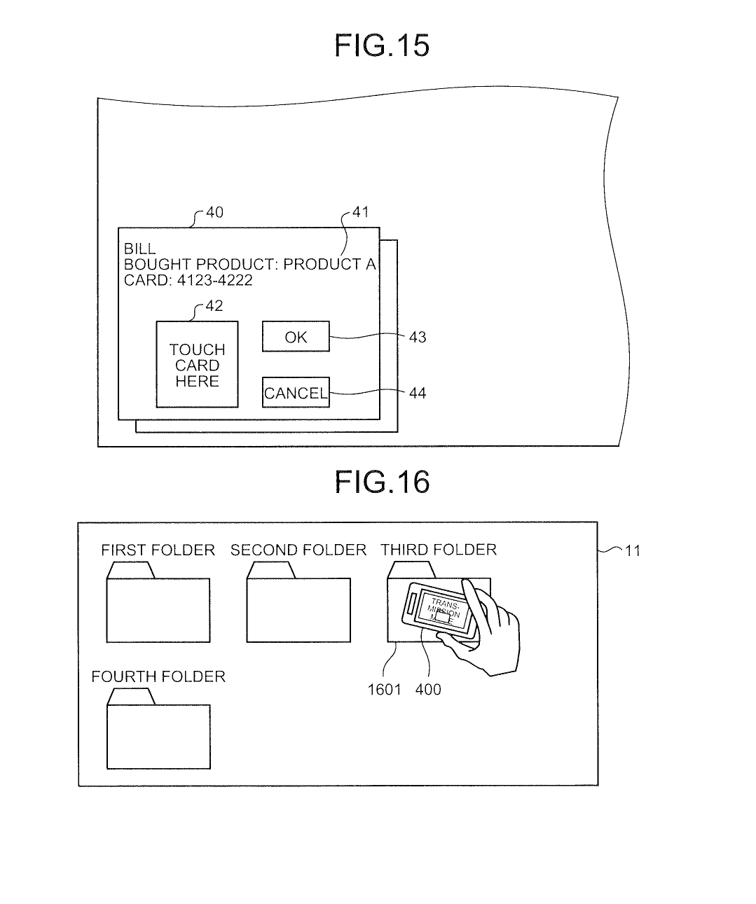

FIG. 15 is a schematic diagram illustrating an example of a screen 40 for payment displayed when a user wants to buy a product. The screen 40 for payment comprises a buying information display section 41 that displays information of the bought product and information of a card used for the payment of the product, a touch section 42, an OK button 43, and a cancel button 44. To the touch section 42, a user touches a card used for payment or the mobile terminal having a payment function.

The determiner 103 determines the position where the touch is made out of the touch section 42, the OK button 43, and the cancel button 44 based on the positional coordinates acquired by the position acquisition module 15. If it is determined that the touch is made on the touch section 42, a program for electric payment, which is activated in the same manner as the processing described above, acquires payment information from the mobile terminal that has transmitted the acceleration detection signal. If no acceleration detection signal is detected, a message is displayed, such as “please touch the touch section with the mobile terminal used for payment”.

If the determiner 103 determines that the touch is made on the OK button 43, the determiner 103 passes the acquired payment information to the activated program for electronic payment and instructs the program for electronic payment to perform the payment. If the determiner 103 determines that the touch is made on the cancel button 44, the determiner 103 deletes the acquired payment information. During the payment, a product coupon may be transferred to the mobile terminal, for example. This processing can be performed in the same procedure as the transfer processing of the music data and the image data described above.

In the operation display 1 in the embodiment, when the mobile terminal is touched to the icon on the display 11, the program corresponding to the icon is activated by acquiring the acceleration detection signal of the mobile terminal at a timing close to the timing of the touch. This makes it possible to activate the program with respect to the intended mobile terminal of the user even if it is detected that a plurality of mobile terminals are approaching the operation display 1. As a result, a problem can be prevented in that data is transferred to a mobile terminal other than the intended mobile terminal and user-friendliness can be enhanced.

In addition, the appropriate attribute information of the mobile terminal is passed to the program to be activated, so that the program can be executed in accordance with the attribute of the mobile terminal. As a result, user-friendliness can be enhanced.

### First Modification of the Embodiment

In the embodiment, transmission or receiving of data is determined in accordance with the icon to which the mobile terminal is touched. The transmission and receiving of data, however, is not limited to being determined in accordance with the icon. For example, the transmission or receiving of data may be determined in accordance with an operation mode set in the mobile terminal. The operation mode is transmitted to the operation display 1 from the mobile terminal by being included in the attribute information.

The operation mode includes a reproduction mode in which the mobile terminal reproduces data, a data transfer mode in which the mobile terminal transmits data, and a data receiving mode in which the mobile terminal receives data.

FIG. 16 is a schematic diagram illustrating an example of the user interface screen when the operation display 1 in a first modification of the embodiment executes the terminal cooperation program 23. As illustrated in FIG. 16, folders, from which data is transmitted and by which data is received, are displayed on the user interface screen. In the mobile terminal 400, the data transmission mode has been set, and the folder to which the data is transmitted or data to be transmitted have been set. Once the mobile terminal 400 is touched to a folder 1601 serving as the data transmission destination, the data is transmitted to the folder 1601. The procedure of the processing is the same as that of the embodiment, and thus description thereof is omitted.

The manner of use of the operation mode is not limited to that in the first modification. The transmission and receiving of data designated by the icon as described in the embodiment and the transmission and receiving of data based on the operation mode may be combined. In this case, if the mobile terminal 400 is in the data receiving mode although the mobile terminal 400 is touched to the uploading icon, the operation display 1 may display a message such as “the mobile terminal cannot transfer data” when receiving the information of the mobile terminal 400. In this way, a program to be activated may be changed in accordance with the operation mode of the mobile terminal.

### Second Modification of the Embodiment

The embodiment does not limit the folder serving as the target of the transmission and receiving of data to a typical folder. A private folder to which access is limited may serve as the target.

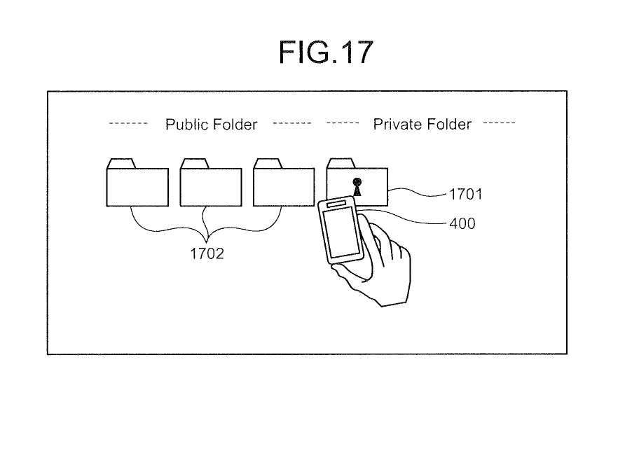

FIG. 17 is a schematic diagram illustrating an example of the user interface screen when an access limitation is canceled so as to access data stored in the storage 14 of the operation display 1 according to a second modification of the embodiment. The data is stored in the storage 14 in a folder structure manner. Data anybody can access is stored in a public folder while data only a specific person can access is stored in the private folder.

In the modification, the access limitation of a private folder 1701 can be canceled using the mobile terminal 400. Public folders 1702 are displayed with icons having no key symbols whereas the private folder 1701 is displayed with the icon having a key symbol. When a specific mobile terminal is touched to the icon having the key symbol, the position acquisition module 15 acquires the positional coordinates of the display position of the private folder 1701, to which the mobile terminal 400 is touched, on the display 11 of the operation display 1. The mobile terminal 400 having transmitted the acceleration detection signal is detected and key information of the mobile terminal 400 is acquired. The determiner 103 determines whether it is permissible to cancel the access limitation based on the acquired key information. The access limitation of the private folder 1701 is canceled in accordance with the determination result.

The programs described in the embodiment are examples of the programs executable by the operation display 1. Other programs are applicable.

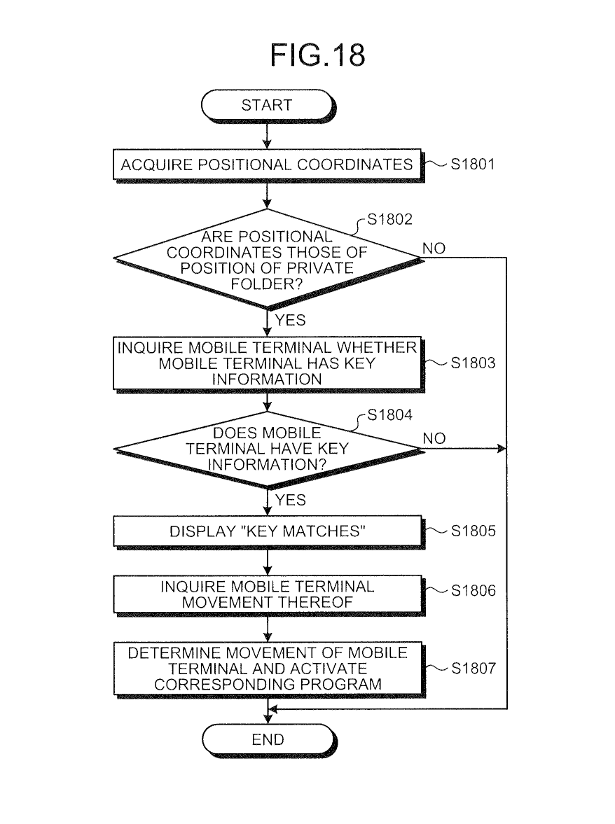

A flow of processing of canceling the key using the mobile terminal is described below with reference to FIG. 18. As illustrated in FIG. 18, the detector 102 acquires the positional coordinates of the touch position of the mobile terminal 400 on the display 11 from the detection signal acquired from the position acquisition module 15 (S1801). The determiner 103 determines whether the acquired positional coordinates are those of the position of the private folder 1701 (S1802). If it is determined that the coordinates are those of the position of the private folder 1701 (Yes at S1802), the determiner 103 inquires the mobile terminal 400 whether the mobile terminal 400 has the key information of the private folder 1701 (S1803). The key information may include two types of information such as information permitting only reading of data and information permitting reading and writing of data. If the determiner 103 determines that the coordinates are not those of the position of the private folder 1701 (No at S1802), the processing ends. Thereafter, other corresponding program is activated or nothing is performed.

The determiner 103 determines whether the mobile terminal 400 has the key information based on the inquiry result (S1804). If it is determined that the mobile terminal 400 has the key information (Yes at S1804), a message of “the key matches” is displayed (S1805). The displayed message is not limited to this. Any message can be displayed. The message may be displayed on the display 11 or on the display 401 of the mobile terminal. If the determiner 103 determines that the mobile terminal 400 does not have the key information (No at S1804), the processing ends.

After the message is displayed at S1805, the terminal cooperation program 23 inquires the mobile terminal 400 about the movement thereof and receives the inquiry result (S1806). The movement of the mobile terminal is indicated by the outputs of the acceleration detector 408 and the tilt detector 409 provided to the mobile terminal 400. The determiner 103 determines the movement of the mobile terminal 400 and identifies the program corresponding to the movement. The activator 104 executes the identified program (S1807). Thereafter, the processing ends.

A case where the key information permits reading and writing of data is described below as an example. When the mobile terminal 400 is rotated at the position of the private folder 1701 about 90 degrees, the mobile terminal 400 transmits the result detected by the acceleration detector 408 and the result detected by the tilt detector 409 to the operation display 1 through the communication IF 17. The operation display 1 executes the program corresponding to the received information. As a result, the limitation of access to the private folder 1701 for reading data therefrom is canceled. When the mobile terminal 400 is rotated at the position of the private folder 1701 about 180 degrees, the limitation of access to the private folder 1701 for reading data therefrom and writing data thereto is canceled.

At this cancellation, a message of the completion of the cancellation may be displayed on the display 11 or the display 401 of the mobile terminal 400. It may be determined either reading or writing is canceled based on the rotational direction of the mobile terminal. When the key information permits only reading of data and the mobile terminal 400 is rotated about 180 degrees, a message of “only reading is permitted to this mobile terminal” may be displayed so as to prompt a user to move the mobile terminal about 90 degrees for canceling the limitation on reading. The operation display 1 can detect the rotation of the mobile terminal 400 by detecting the touch position on the display 401 of the mobile terminal 400 or by acquiring information of the postural direction of the mobile terminal 400 therefrom, for example. A sliding of the mobile terminal may be detected instead of detecting the rotation thereof.

### Third Modification of the Embodiment

Any target can be operated by the mobile terminal as long as the target is data. For example, pages in any website can be operated. In a third modification of the embodiment, the mobile terminal operates a page in a website.

For example, the operation display 1 in the third modification displays a page of a website on the display 11. When the access to the website is limited, a user performs a predetermined movement on the display 11 using the mobile terminal 400 and processing is performed such that the operation display 1 detects the movement and cancels the access limitation.

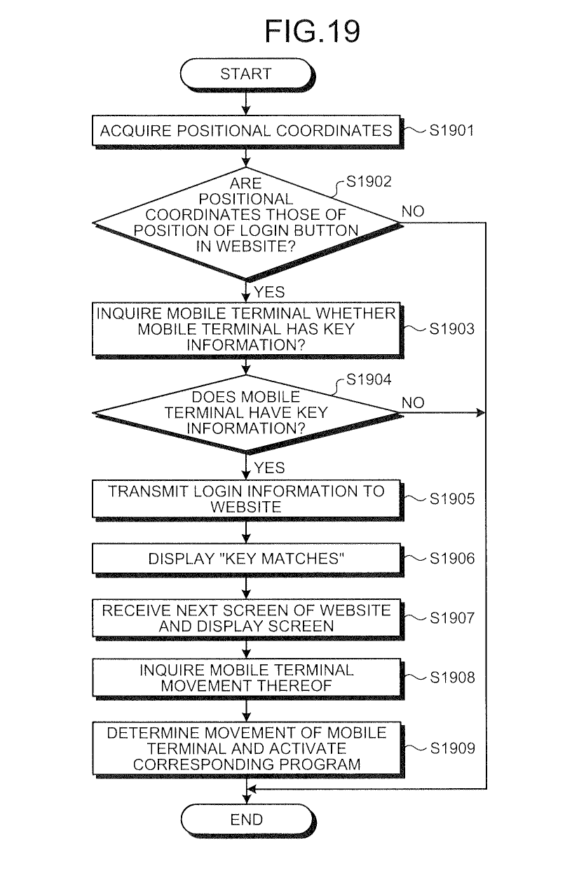

A flow of processing of canceling the key using the mobile terminal is described below with reference to FIG. 19. As illustrated in FIG. 19, the detector 102 acquires the positional coordinates of the touch position of the mobile terminal 400 on the display 11 from the detection signal acquired from the position acquisition module 15 (S1901). The determiner 103 determines whether the acquired positional coordinates are those of the position of a login button on the page of the website (S1902). If it is determined that the coordinates are those of the position of the login button of the page of the website (Yes at S1902), the determiner 103 inquires the mobile terminal 400 whether the mobile terminal 400 has the key information of the website (S1903). The key information may include various types of information such as information only permitting the access to the website and information permitting the access to the website using administrative access. If the determiner 103 determines that the coordinates are not those of the position of the login button (No at S1902), the processing ends.

The determiner 103 determines whether the mobile terminal 400 has the key information based on the inquiry result (S1904). If it is determined that the mobile terminal 400 has the key information (Yes at S1904), login information is transmitted to the website (S1905). Based on the login information, authentication processing is performed by the website. Thereafter, a message of “the key matches” is displayed (S1906). The displayed message is not limited to this. Any message can be displayed. The message may be displayed on the display 11 or on the display 401 of the mobile terminal. If it is determined that the mobile terminal 400 does not have the key information (No at S1904), the processing ends.

After the display at S1905, the operation display 1 receives the authentication result from the website and displays the next screen (screen after the authentication is performed) of the website (S1907).

Thereafter, the terminal cooperation program 23 of the operation display 1 inquires the mobile terminal 400 about the movement thereof and receives the inquiry result (S1908). The movement of the mobile terminal is indicated by the outputs of the acceleration detector 408 and the tilt detector 409 provided to the mobile terminal 400. The determiner 103 determines the movement of the mobile terminal 400 and identifies the processing corresponding to the movement. The activator 104 performs the identified processing (e.g., instruct the website to display the next screen) (S1909).

In the modification, the processing described in the embodiment and the processing described in the modification may be combined. For example, moving image data, music data, and photograph data may be exchanged with the logged-in website.

In the embodiment and the modifications described above, when communication is made between the operation display and the mobile terminal, operation to make communication between two devices can be intuitively done without performing the operation to select the mobile terminal by the operation using the operation display or to select the operation display by the operation using the mobile terminal. As a result, a communication apparatus can be provided that comprises the operation display having improved operability and mobile terminals.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display processor comprising:
a receiver configured to receive from a mobile terminal an acceleration detection signal indicating acceleration generated in the mobile terminal;
a display comprising a display area;
a detector configured to detect a touch on the display area of the display; and
a controller configured to perform processing corresponding to the display area when a difference between a time when the detector detects the touch and a time when the receiver receives the acceleration detection signal is within a predetermined threshold.

2. The display processor of claim 1, wherein the controller is configured to perform processing different from the processing corresponding to the display area when the difference between the time when the detector detects the touch and the time when the receiver receives the acceleration detection signal is larger than the predetermined threshold.

3. The display processor of claim 1, wherein, for respective display areas, the controller is configured to perform different types of processing in accordance with a type of the mobile terminal that has transmitted the acceleration detection signal.

4. The display processor of claim 1, wherein the controller transmits information indicated by the display area to the mobile terminal that has transmitted the acceleration detection signal as the processing corresponding to the display area.

5. The display processor of claim 1, wherein the controller is configured to perform different types of processing in accordance with operation set in the mobile terminal.

6. A display processing method comprising:
receiving from a mobile terminal an acceleration detection signal indicating acceleration generated in the mobile terminal;
detecting a touch on a display area of a display; and
performing processing corresponding to the display area when a difference between a time when the touch is detected at the detecting and a time when the acceleration detection signal is received at the receiving is within a predetermined threshold.
